(19) United States
(12) Patent Application Publication
(10) Pub. No.: US 2021/0188031 A1
(43) Pub. Date: Jun. 24, 2021

(54) DRIVETRAIN FOR A VEHICLE

(71) Applicant: Spicer Gelenkwellenbau GmbH, Essen (DE)

(72) Inventors: Jeff Dutkiewicz, Ottawa Hills, OH (US); Alexander Neginskiy, Essen (DE); Thomas Stein, Essen (DE)

(73) Assignee: Spicer Gelenkwellenbau GmbH, Essen (DE)

(21) Appl. No.: 17/121,947

(22) Filed: Dec. 15, 2020

(30) Foreign Application Priority Data
Dec. 20, 2019 (DE) 20 2019 107 168.0

(51) Int. Cl. B60G 9/02; B60G 9/00

(52) U.S. Cl. CPC B60G 9/027; B60G 9/003; B60G 2200/31; B60G 2300/50; B60G 2204/18; B60G 2204/19; B60G 2200/324

(57) ABSTRACT

A drivetrain for a vehicle, such as a commercial vehicle, may have an electric motor with a maximum output torque of at least 4000 Nm. The drivetrain may also have at least one constant velocity joint and an axle differential. The electric motor may be connected or connectable to the axle differential via the at least one constant velocity joint.

### FIELD

The object of this document is a drivetrain for a vehicle as well as a vehicle having this drive train, in particular a commercial vehicle, for example for a bus, a van or the like.

### BACKGROUND

Vehicle drivelines usually have an engine connected or connectable to an axle differential via a drive shaft. A drive torque generated by the engine can then be transmitted to the drive half axle via the axle differential. The drive shaft is often connected or connectable to the engine shaft or a transmission output shaft and/or to the axle differential via cardan joints.

Cardan joints are characterized by their low friction losses and their mechanical stability. However, they have the disadvantage that the transmission of torque and rotational speed through the joint depends on the momentary angle of rotation of the joint and is therefore subject to periodic fluctuations. Particularly when transmitting large torques, as is necessary to drive heavy vehicles, this can lead to heavy mechanical loads on the components connected via the cardan joint, which often result in rapid wear of the components. Furthermore, it is known that in particular the periodic fluctuations that occur during torque transmission via a cardan joint to the ring gear of an axle differential generate an undesirable rattling noise. This is particularly pronounced when an electric motor is used to generate torque, which itself usually operates relatively quietly.

### SUMMARY

The present disclosure is therefore based on the object of creating a drivetrain for a vehicle, in particular for a commercial vehicle, with a drive engine and an axle differential, which ensures a torque transmission from the drive engine to the axle differential with as little wear and noise as possible.

This object is solved by a drivetrain for a vehicle with the features of claim 1 and by a vehicle having this drive train. Special configurations are described in the dependent claims.

Therefore, a drivetrain for a vehicle is proposed, in particular for a commercial vehicle:

an electric motor with a maximum output torque of at least 4000 Nm,
at least one constant velocity joint, also called homokinetic joint, and
an axle differential,
the electric motor being connected or connectable to the axle differential via the at least one constant velocity joint.

Because the electric motor is or can be connected to the axle differential via at least one constant velocity joint, the output torque of the electric motor can be transmitted evenly to the axle differential. This allows mechanical stress on the axle differential and/or the electric motor to be significantly reduced compared to drivetrains without constant velocity joint between the electric motor and the axle differential. In particular, it has been shown that the use of a constant velocity joint for torque transmission between the electric motor and the axle differential can effectively suppress or even completely prevent the unwanted rattling noise that can occur when transmitting large torques to the axle differential by means of a cardan joint.

The advantages of the drivetrain proposed here over conventional powertrains become particularly clear when using drives with high output torques, such as those used in heavy commercial vehicles. For example, the electric motor of the drivetrain proposed here may have a maximum output torque of at least 5000 Nm, of at least 6000 Nm, or of at least 7000 Nm.

Usually the constant velocity joint is connected or connectable to a drive axle via the axle differential. A speed ratio between the drive shaft and the drive axle is typically greater in heavy commercial vehicles, where the advantages of the drivetrain proposed here are particularly evident, than in lighter passenger cars. For example, the speed ratio between the constant velocity joint and the drive axle in the drivetrain proposed here can be at least 3:1, at least 4:1, at least 5:1 or at least 6:1.

The tires of heavy commercial vehicles are usually larger in diameter than the tires of lighter passenger cars. For example, the drive axle of the drivetrain proposed here may have a first half axle connected or connectable to a first drive wheel, with a first tire mounted on the first drive wheel. Moreover, the drive axle of the drivetrain proposed here may have a second half axle connected or connectable to a second drive wheel, with a second tire mounted on the second drive wheel. For example, a diameter of the first tire and the second tire may then each be at least 0.50 m, at least 0.60 m, at least 0.70 m or at least 0.80 m.

The electric motor can be connected or be connectable to the axle differential via a maximum two-stage transmission. Alternatively, the rotor of the electric motor may be connected or be connectable to the at least one constant velocity joint without an interposed transmission. A speed ratio between the rotor of the electric motor and the at least one constant velocity joint can therefore be in particular 1:1.

The drivetrain may also have a drive shaft, in which case the electric motor is connected or connectable to the axle differential via the drive shaft. The electric motor can then, for example, be connected or connectable to the drive shaft via a first constant velocity joint. Moreover, alternatively or additionally, the drive shaft can also be connected or connectable to the axle differential via a second constant velocity joint.

The drive shaft may comprise a first telescopic arm and an at least partially tubular second telescopic arm, the first telescopic arm being at least partially accommodated in the second telescopic arm, in particular in the tubular section of the second telescopic arm. The first telescopic arm and the second telescopic arm can then be moved relative to one another along a longitudinal axis of the drive shaft in order to adjust a length of the drive shaft. This allows for mechanical stress on the electric motor and/or the axle differential to be further reduced and their service life further extended.

For example, the first telescopic arm and the second telescopic arm can be connected to each other by a splined joint to prevent rotation. For example, a typically substantially cylindrical outer surface of the portion of the first telescopic arm received in the second telescopic arm and a typically equally substantially cylindrical inner surface of the tubular portion of the second telescopic arm may have interlocking splines and/or grooves extending, for example, along the longitudinal direction of the drive shaft.

The electric motor can be connected via a first H-shaped flange to the first constant velocity joint, via which the electric motor is connected or connectable to the drive shaft. Moreover, alternatively or additionally, the axle differential can be connected via a second H-shaped flange to the second constant velocity joint, via which the drive shaft is connected or can be connected to the axle differential. For example, the second H-shaped flange can be connected to a pinion that engages with a ring gear of the axle differential.

A vehicle, in particular a commercial vehicle with the drivetrain described above is also proposed. For example, the vehicle may have an unladen weight of at least 7 tons, at least 10 tons, at least 15 tons or at least 20 tons.

A version of the vehicle and drivetrain proposed here is shown in the figures and is explained in more detail in the following description. In the drawings:

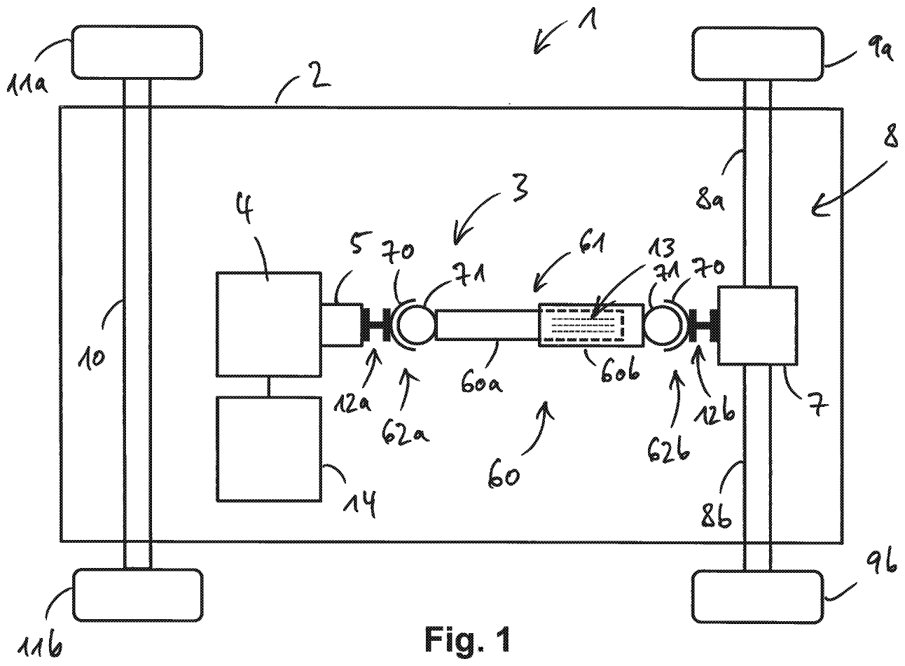

FIG. 1 schematically shows a vehicle with a drivetrain of the type proposed here, e.g. a local bus, in a plan view,

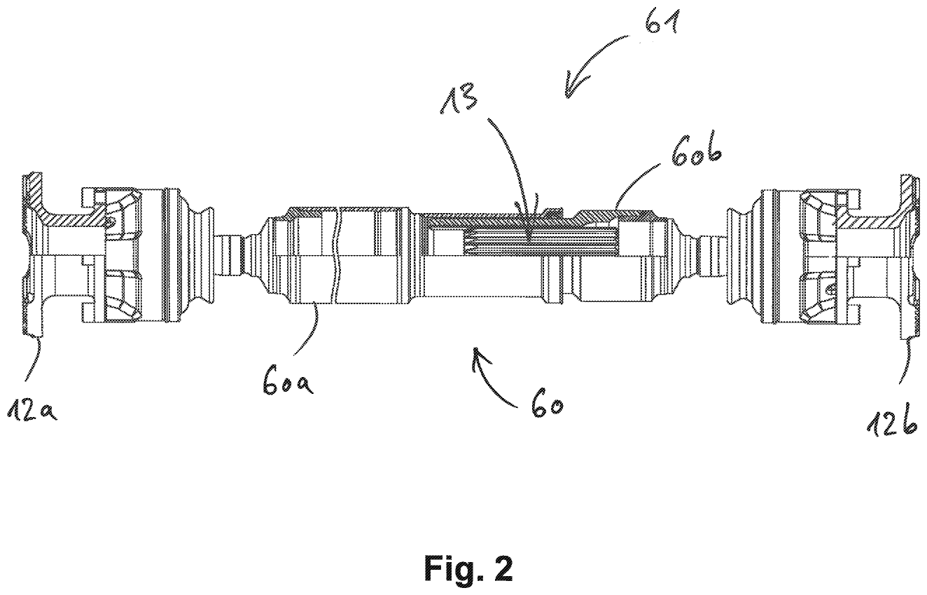

FIG. 2 schematically shows a sectional view of a constant velocity universal joint shaft used in the drivetrain according to FIG. 1 and

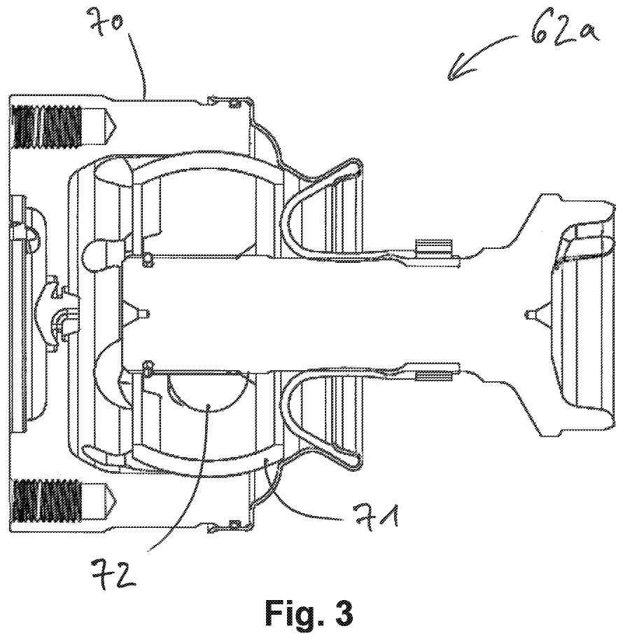

FIG. 3 schematically a constant velocity joint used in the drivetrain according to FIG. 1 in a sectional view.

### DETAILED DESCRIPTION

FIG. 1 shows a schematic representation of vehicle 1 of the type proposed here, which may be a commercial vehicle, e.g. a bus for local public transport or the like. For example, vehicle 1 may have a length of at least 8 m, a height of at least 2.5 m, and a width of at least 2 m. Vehicle 1 typically has an unladen weight of at least 10 tons. Vehicle 1 has a chassis 2, which may, for example, be made entirely or at least partly of steel, aluminium or a carbon fibre composite.

Furthermore, vehicle 1 has a drivetrain 3. The latter comprises an electric motor 4, which is connected, via an inverter not shown here, with an energy storage device 14, e.g. with a rechargeable battery. As the case may be, vehicle 1 may be a hybrid vehicle with, in addition to electric motor 4, an internal combustion engine not shown here. The electric motor 4 can be designed as a synchronous motor, for example. However, the electric motor 4 shown here can also be substituted by an electric motor of another type, for example by an asynchronous motor or by a DC motor. The electric motor 4 has a maximum output torque of at least 5000 Nm. In other embodiments, however, the electric motor 4 can also have a maximum output torque of at least 6000 Nm or at least 7000 Nm.

In the embodiment shown here, the drivetrain 3 further comprises a two-stage transmission 5, a constant velocity universal joint shaft 60 with a drive shaft 61 and constant velocity joints or homokinetic joints 62a and 62b, an axle differential 7, a drive axle 8 with two drive half axles 8a and 8b and two drive wheels 9a, 9b, each of which can be driven via one of the drive half axles 8a, 8b. Vehicle 1 also has a non-driven axle 10 with non-driven wheels 11a, 11b. For example, tires mounted on the driving wheels 9a, 9b and the non-driving wheels 11a, 11b of the heavy commercial vehicle 1 shown here each have a tire diameter of at least 0.50 m or at least 0.60 m.

A torque generated by the electric motor 4 can be transmitted to the half axles 8a, 8b via the two-stage transmission 5, the constant velocity drive shaft 60 and the axle differential 7 and via these to the drive wheels 9a, 9b. The transmission ratio, i.e. the speed ratio between the constant velocity universal joint shaft 60 and the drive axle 8 is at least 3:1 for the drivetrain 3 shown here. However, larger speed ratios between the constant velocity drive shaft 60 and the drive axle 8 are also conceivable, e.g. at least 4:1, at least 5:1 or at least 6:1. Such high transmission ratios between the drive shaft 61 and the drive axle 8 are particularly advantageous for heavy vehicles driven by powerful engines with large maximum output torques. For example, where applicable, this can reduce stress on the components used for torque transmission between the constant velocity drive shaft 60 and the drive axle 8 and extend their service life.

In the embodiment shown here, the constant velocity universal joint shaft 60 is connected at its ends, in particular via a first H-shaped flange 12a to the transmission 5 and via a second H-shaped flange 12b to the axle differential 7, in particular to a ring gear of the axle differential 7 which is not explicitly shown here. In modified designs, the constant velocity universal joint shaft 60 can also be connected to the electric motor 4 or to the transmission 5 and axle differential in a different way than by means of the H-shaped flanges 12a, 12b. The H-shaped flanges 12a, 12b are therefore only optional components of the drivetrain 3.

The transmission 5 may also have more than the two stages described above. Likewise, however, the drivetrain 3 proposed here may dispense with the transmission 5 altogether. It is therefore conceivable that a speed ratio between the rotor of the electric motor 4 and the constant velocity joint shaft 6 or the constant velocity joints 62a, 62b is 1:1.

The drive shaft 61 may comprise two telescopic arms as shown here, in particular a first telescopic arm 60a and a second telescopic arm 60b. Here the second telescopic arm 60b is tubular, is at least in sections. The first telescopic arm 60a is at least partially accommodated in the tubular section of the second telescopic arm 60b, and the telescopic arms 60a, 60b are movable relative to each other along a longitudinal axis of the drive shaft 61. For example, the length of the drive shaft can be changed by at least 5 percent or at least 10 percent by moving the telescopic arms 60a, 60b relative to each other. For example, vibrations of drivetrain 3 occurring during operation can be compensated. This can also reduce the mechanical stress on at least some drivetrain components and extend the service life of powertrain 3.

A rotationally fixed connection between the telescopic arms 60a, 60b of the drive shaft 61 can be ensured, for example, by a splined connection 13. This may comprise splines or ribs running along the longitudinal direction of the drive shaft 61 on an outer surface of the first telescopic arm 60a and complementary grooves or channels also running along the longitudinal direction of the drive shaft 61 on an inner surface of the tubular section of the second telescopic arm 60b, the splines or ribs of the first telescopic arm 60a being interlocked with the grooves or channels of the second telescopic arm 60b.

A detailed illustration of the constant velocity universal joint shaft 60 is shown in FIG. 2. This also shows the H-shaped connecting flanges 12a, 12b, which are each connected in the axial direction with one of the constant velocity joints 62a, 62b.

FIG. 3 shows a section of the first constant velocity joint 62a, which may be, for example, of a type that is known per se and which, in the case of the embodiment of the drivetrain 3 shown in FIG. 1, connects the transmission 5 to the drive shaft 61. The second constant velocity joint 62b can be designed in the same way as the first constant velocity joint 62a shown in FIG. 3. The constant velocity joint 62a has an outer ring 70, an inner ring 71 and rolling elements 72 arranged between the rings 70, 71, which can slide or roll between the rings 70, 71 in running grooves not explicitly shown here. The outer ring 70 is non-rotatably connected to an output shaft of the transmission 5, and the inner ring 71 is non-rotatably connected to the drive shaft 60.

The constant velocity joints 62a, 62b are designed in such a way that a torque transmitted between rings 70, 71 is always independent of a relative arrangement of rings 70, 71 to each other. In this manner, the constant velocity joints 62a, 62b can transmit an output torque generated by the electric motor 4 particularly evenly to the axle differential 7. By transmitting the output torque of the electric motor 4 to the axle differential 7 by means of the constant velocity universal joint shaft 60 described above and shown in the figures instead of a cardan shaft as is the case with drivetrains known from the state of the art, the material stress on the drive train components and, in particular, non-uniform rotational movement occurring at the input of the axle differential 7 and the undesirable noises generated as a result, even at high output torques generated by the electric motor 4, can be significantly reduced compared with known drivetrains.

What is claimed is:

1. A drivetrain for a vehicle, comprising:
i. an electric motor with a maximum output torque of at least 4000 Nm,
ii. at least one constant velocity joint and
iii. an axle differential,
iv. the electric motor being connected or connectable to the axle differential via the at least one constant velocity joint.

2. The drivetrain according to claim 1, wherein the maximum output torque of the electric motor is at least 7000 Nm.

3. The drivetrain according to claim 1, wherein the at least one constant velocity joint is connected to a drive axle via the axle differential, wherein a speed ratio between the constant velocity joint and the drive axle is at least 5:1.

4. The drivetrain according to claim 3, wherein the drive axle comprises a first half axle connected to a first drive wheel with a first drive wheel tire and a second half axle connected to a second drive wheel with a second drive wheel tire, wherein a diameter of the first drive wheel tire and the second drive wheel tire is at least 0.60 m.

5. The drivetrain according to claim 1, whereby the electric motor is connected or connectable to the axle differential via a maximum two-stage transmission.

6. The drivetrain according to claim 1, wherein a speed ratio between the rotor of the electric motor and the at least one constant velocity joint is 1:1 or at least 1:1.

7. The drivetrain according to claim 1, wherein the electric motor is connected to a drive shaft via a first constant velocity joint and wherein the driveshaft is connected to the axle differential via a second constant velocity joint.

8. The drivetrain according to claim 1, wherein the driveshaft comprises a first telescopic arm and an at least sectionally tubular second telescopic arm, wherein the first telescopic arm is at least partially accommodated in the second telescopic arm and the first telescopic arm and the second telescopic arm are movable relative to each other along a longitudinal axis of the drive shaft in order to adjust a length of the drive shaft.

9. The drivetrain according to claim 8, wherein the first telescopic arm and the second telescopic arm are connected to one another in a rotationally fixed manner by a splined connection.

10. The drivetrain according to claim 7, wherein the electric motor is connected to the first constant velocity joint via a first H-shaped flange.

11. The drivetrain according to claim 10, wherein the second constant velocity joint is connected to the axle differential via a second H-shaped flange.

12. The drivetrain according to claim 11, wherein the second constant velocity joint is connected via the second H-shaped flange to a pinion which is in engagement with a ring gear of the axle differential.

13. A commercial vehicle with a drivetrain according to claim 1, wherein an unladen weight of the vehicle is at least 15 tons.
